(19) United States
(12) Patent Application Publication
(10) Pub. No.: US 2005/0175345 A1
(43) Pub. Date: Aug. 11, 2005

(54) Wavelength multiplexing device and optical transmission module provided with the same

(76) Inventors: Mikihiro Shimada, Daito (JP); Nobuki Itoh, Kitakatsuragi-gun (JP); Tsuguhiro Korenaga, Katano (JP); Kunio Hibino, Hirakata (JP)

Correspondence Address: WENDEROTH, LIND & PONACK, L.L.P., 2033 K STREET N. W., SUITE 800, WASHINGTON, DC, 20006-1021, US

(21) Appl. No.: 11/041,210

(22) Filed: Jan. 25, 2005

(30) Foreign Application Priority Data
Jan. 26, 2004 (JP) 2004-017657

(51) Int. Cl. H04J 14/02

(52) U.S. Cl. 398/79

(57) ABSTRACT

A wavelength multiplexing device has an emitter capable of independently emitting at least two optical signals for at least two kinds of wavelength, respectively and a transmitter including a plurality of optical waveguides into which the optical signals emitted by the emitter are coupled and which independently transmit the coupled optical signals, respectively. While coupling optical signals with the same wavelength among the optical signals emitted by the emitter into the optical waveguides different from each other, the transmitter couples optical signals with wavelengths different from each other into a same optical waveguide.

### CROSS-REFERENCE TO RELATED APPLICATION

This application is based on Application No. 2004-017657 filed in Japan, the content of which is hereby incorporated by reference.

### BACKGROUND

1. Technical Field

The present invention relates to a wavelength multiplexing device for performing wavelength multiplexing of a plurality of optical signals to be transmitted, and more particularly to a wavelength multiplexing device using a surface light emitting element array. The present invention also relates to an optical transmission module provided with the above wavelength multiplexing device

2. Description of the Background Art

In recent years, research for applying an optical transmission system to a public correspondence or a computer network has been made actively. In such an optical transmission system, since transmitting large capacity data at high speed is required, a wavelength multiplex transmission is expected as a leading technology. Moreover, in an inside of a portable device, such as a cellular phone terminal and a digital camera, applying the wavelength multiplexing device also to a data bus for transmitting data at high speed has been received attention.

In order to achieve such a wavelength multiplex transmission, a wavelength multiplexing device provided with a light emitting portion which oscillates a plurality of wavelengths is required. However, in a wavelength multiplexing device in which light emitting portions for emitting a single wavelength are combined, since a large number of optical elements, such as a mirror or a prism for composing optical paths, have been required, there has been a limit on its miniaturization. For this reason, a wavelength multiplexing device using a surface light emitting element array has received attention at present.

As a conventional art which has achieved the wavelength multiplex transmission using the surface light emitting element array, a device for coupling an optical signal which a surface type light source array oscillates into an optical fiber has been proposed (refer to Japanese patent publication No. 2,848,279, particularly to paragraphs [0010] through [0011], and FIG. 1).

FIG. 12 is a schematic diagram for explaining a configuration of the conventional art described in the Japanese patent publication No. 2,848,279. A device shown in FIG. 12 comprises a light source array 91, a lens array 92, a lens 93, and an optical fiber 94.

The light source array 91 includes nine light emitting portions 91a through 91i which are integrally formed on the same element. The light emitting portion 91a oscillates an optical signal with a wavelength of λ1 as a diverging light based on a control signal from an external source. The light emitting portion 91b oscillates an optical signal a wavelength of λ2 as a diverging light based on the control signal from the external source. At this time, an emission of the light emitting portion 91b is controlled independently of that of the light emitting portion 91a. Other light emitting portions have relationships in a manner similar to that mentioned above. In other words, all of the nine light emitting portions 91a through 91i can independently oscillate the optical signals with nine wavelengths of λ1 through λ9, all of which are different from each other, as the diverging light based on the control signals from the external source.

The lens array 92 comprises lenses 92a through 92i formed on the same substrate. The lens 92a of the lens array 92 is arranged on an optical axis of the optical signal emitted by the light emitting portion 91a. The lens 92b is arranged on an optical axis of the optical signal emitted by the light emitting portion 91b. Other light emitting portions have relationships in a manner similar to that mentioned above. In other words, the lenses 92c through 92i are arranged on optical axes of the optical signals emitted by the light emitting portions 91c through 91i to which reference numerals with suffix correspond, respectively. Meanwhile, the optical fiber 94 is formed with a material capable of performing the wavelength multiplex transmission of the optical signals with the wavelengths of λ1 through λ9 which are emitted by the light emitting portions 91a through 91i.

In the above configuration, the optical signal which is emitted by the light emitting portion 91a of the light source array 91 is deflected in parallel to the optical axis by the lens 92a of the lens array 92, and is condensed at an end face of the optical fiber 94 by the lens 93. Similarly, the optical signal which is emitted by the light emitting portion 91b as the diverging light is deflected in parallel to the optical axis by the lens 92b, and is condensed at the end face of the optical fiber 94 by the lens 93. Also with regard to the optical signals from all other light emitting portions, the optical signal which is emitted by each of the light emitting portions 91c through 91i as the diverging light is similarly deflected in parallel to an optical axis by the corresponding lenses 92c through 91i, and is condensed at the end face of the optical fiber 94 by the lens 93.

All optical signals condensed at the end face of the optical fiber 94 are coupled into the optical fiber 94, and are transmitted as the wavelength multiplex signal by the optical fiber 94. At this time, the emissions of the nine optical signals are controlled independently. The optical fiber 94 can therefore superimpose and transmit the optical signals emitted by the nine light emitting portions 91a through 91i by nine times.

In addition, according to an alternative conventional art, a wavelength multiplex transmission system provided with a surface light emitting element, a plurality of optical fibers, an optical coupler, and an optical fiber for transmission is proposed (refer to Japanese patent publication No. 2953392, and particularly to a description of paragraphs [0008], and [0012] through [0013], and FIG. 1). According to this conventional art, the surface light emitting element is capable of emitting an optical signal with single wavelength having a wide spectral band width. In addition, a plurality of optical fibers have wavelength transparent areas different from each other, respectively. Therefore, as a result of transmitting through a plurality of optical fibers, the optical signal emitted by the surface light emitting element is split into optical signals with wavelengths different from each other. The split optical signals are coupled into the optical fiber for transmission via the optical coupler, thereby making it possible to achieve the wavelength multiplex transmission.

According to the conventional art described in the Japanese patent publication No. 2,848,279, there is needed the surface light emitting element array in which the light emitting portions with emission wavelengths, all of which are different from each other, are integrally formed on the same element. However, in such a surface light emitting element array described above, since different structures have to be formed for every light emitting portion on the same element, its manufacturing may be forced into very complicated process, thereby making it hard to manufacture the surface light emitting element array. As a result of this, the surface light emitting element array has not been able to be supplied at a low cost, and a cost rise of the wavelength multiplexing device has not been able to be avoided.

On the other hand, the conventional art described in the Japanese patent publication No. 2953392 has required an optical fiber having desired light transmission characteristics, so that it has been difficult to make the wavelength multiplexing device compact. Meanwhile, according to the conventional art described in the Japanese patent publication No. 2953392, since the optical coupler for further coupling the optical signal transmitted through a plurality of optical fibers into the optical fiber is required, there is needed a more expensive optical element. For this reason, a cost rise of the wavelength multiplexing device has not been able to be avoided.

### OBJECT AND SUMMARY

In order to solve the problem described above, a novel and improved wavelength multiplexing device and optical transmission module will be disclosed as follows. A wavelength multiplexing device has an emitter capable of independently emitting at least two optical signals for at least two kinds of wavelength, respectively and a transmitter including a plurality of optical waveguides into which the optical signals emitted by the emitter are coupled and which independently transmit the coupled optical signals, respectively. While coupling optical signals with the same wavelength among the optical signals emitted by the emitter into the optical waveguides different from each other, the transmitter couples optical signals with wavelengths different from each other into a same optical waveguide.

According to a configuration described above, without using the light emitting portion for emitting the optical signals with the wavelengths, all of which are different, it is possible to transmit superimposed optical signals, the number of which is more than that of wavelengths, as wavelength multiplex. Moreover, since the emitter and the transmitter can be coupled without using a complicated optical coupler or the like, that makes it possible to provide a wavelength multiplexing device in excellent productivity at a low cost.

Characteristics, aspects, and effects of the above novel wavelength multiplexing device and optical transmission module will be clearer according to the following detailed discussion, as referring to the accompanying drawings.

### BRIEF DESCRIPTION OF THE DRAWINGS

This and other objects and features will become clear from the following description, taken in conjunction with the preferred embodiments with reference to the accompanied drawings in which:

FIG. 1 is a schematic diagram showing a configuration of a wavelength multiplexing device according to a first embodiment;

FIG. 2 is a schematic diagram showing a configuration of a wavelength multiplexing device according to a second embodiment;

FIG. 3 is a schematic diagram showing a configuration of a wavelength multiplexing device according to a third embodiment;

FIG. 4 is a schematic diagram showing a configuration of a wavelength multiplexing device according to a fourth embodiment;

FIG. 5 is a schematic diagram showing a configuration of a wavelength multiplexing device according to a fifth embodiment;

FIG. 6 is a schematic diagram showing a configuration of a wavelength multiplexing device according to a sixth embodiment;

FIG. 7 is a schematic diagram showing a configuration of a wavelength multiplexing device according to a seventh embodiment;

FIG. 8 is a schematic diagram showing a configuration of a wavelength multiplexing device according to an eighth embodiment;

FIG. 9 is a side view of an optical transmission module according to a ninth embodiment;

FIG. 10 is a side view showing a usage example of the optical transmission module according to the ninth embodiment;

FIG. 11A is an external view of a portable telephone device according to the 10th embodiment;

FIG. 11B is a view of an internal configuration of the portable telephone device according to the 10th embodiment; and

FIG. 12 is a schematic diagram for explaining a configuration of a conventional art described in Japanese patent publication No. 2,848,279.

### DESCRIPTION OF THE PREFERRED EMBODIMENTS

Hereafter, referring to the drawings, description will be made of a wavelength multiplexing device according to embodiments. Incidentally, each drawing will only show a schematic diagram for discussion, and not be intended to indicate an accurate relative dimension. In addition, all members for mounting each component will be omitted.

### First Embodiment

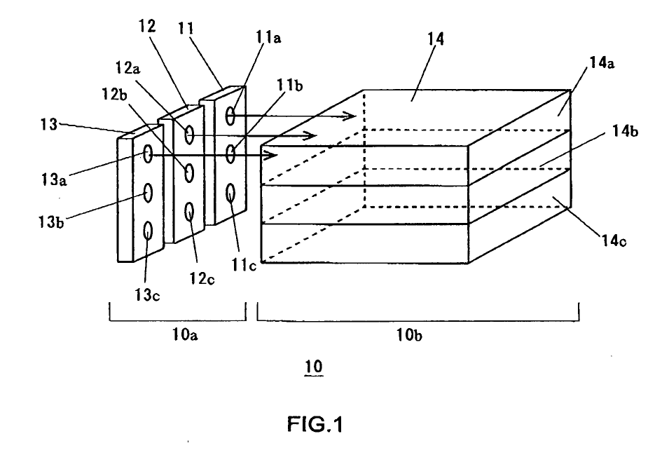

FIG. 1 is a schematic diagram showing a configuration of a wavelength multiplexing device 10 according to a first embodiment. The wavelength multiplexing device 10 comprises an emitter 10a and a transmitter 10b. The emitter 10a includes a surface light emitting element array 11, a surface light emitting element array 12, and a surface light emitting element array 13. The transmitter 10b includes an optical waveguide 14.

The surface light emitting element array 11 comprises a light emitting portion 11a, a light emitting portion 11b, and a light emitting portion 11c. The light emitting portions 11a through 11c are integrally formed along one direction on the same element. The light emitting portion 11a oscillates an optical signal with a wavelength of λ1 as a diverging light based on a control signal from an external source. The light emitting portion 11b oscillates an optical signal with the wavelength of λ1 as a diverging light independently of the light emitting portion 11a based on a control signal from the external source. The light emitting portion 11c oscillates an optical signal with the wavelength of λ1 as a diverging light independently of the light emitting portion 11a and the light emitting portion 11b based on a control signal from the external source. As mentioned above, all light signals that the light emitting portions 11a through 11c oscillate have the wavelength of λ1. Each surface light emitting element array is a surface light emitting type semiconductor laser. In addition, a spacing between the light emitting portion 11a and the light emitting portion 11b is almost equal to a spacing between the light emitting portion 11b and the light emitting portion 11c.

The surface light emitting element array 12 comprises a light emitting portion 12a, a light emitting portion 12b, and a light emitting portion 12c. A shape of the surface light emitting element array 12 is almost the same as that of the surface light emitting element array 11. That is, the light emitting portions 12a through 12c are integrally formed along one direction on the same element. In addition, a spacing between the light emitting portion 12a and the light emitting portion 12b is almost equal to a spacing between the light emitting portion 12b and the light emitting portion 12c. However, in a point that light signals that the light emitting portions 12a through 12c oscillate have a wavelength of λ2 different from that of λ1, the surface light emitting element array 12 is different from the surface light emitting element array 11. Incidentally, an arrangement of the light emitting portions 12a through 12c is parallel to an arrangement of the light emitting portions 11a through 11c. In addition, a spacing between the light emitting portions 12a and 12b is equal to the spacing between the light emitting portions 11a and 11b. Further, a spacing between the light emitting portions 12b and 12c is equal to the spacing between the light emitting portions 11b and 11c.

The surface light emitting element array 13 comprises a light emitting portion 13a, a light emitting portion 13b, and a light emitting portion 13c A shape of the surface light emitting element array 13 is almost the same as that of the surface light emitting element array 11. That is, the light emitting portions 13a through 13c are integrally formed along one direction on the same element. In addition, a spacing between the light emitting portion 13a and the light emitting portion 13b is almost equal to a spacing between the light emitting portion 13b and the light emitting portion 13c. However, in a point that light signals that the light emitting portions 13a through 13c oscillate have a wavelength of λ3 different from that of λ1 and λ2, the surface light emitting element array 13 is different from the surface light emitting element array 11. Incidentally, an arrangement of the light emitting portions 13a through 13c is parallel to the arrangement of the light emitting portions 11a through 11c. In addition, a spacing between the light emitting portions 13a and 13b is equal to the spacing between the light emitting portions 11a and 11b. Further, a spacing between the light emitting portions 13b and 13c is equal to the spacing between the light emitting portions 11b and 11c.

The optical waveguide 14 is formed by stacking three optical waveguides 14a through 14c which have the same configuration independent of each other. The optical waveguide 14a is a multimode optical waveguide of step index type formed such that clad portions having a refractive index lower than that of a core portion are disposed on upper and lower sides of the core portion having a predetermined refractive index, and transmits the optical signals with the wavelength of λ1, the wavelength of λ2, and the wavelength of λ3 that the respective light emitting portions oscillate. An edge portion of the optical waveguide 14a is opposed to the light emitting portion 11a, the light emitting portion 12a, and the light emitting portion 13a. An edge portion of the optical waveguide 14b is also opposed to the light emitting portion 11b, the light emitting portion 12b, and the light emitting portion 13b. In addition, an edge portion of the optical waveguide 14c is also opposed to the light emitting portion 11c, the light emitting portion 12c, and the light emitting portion 13c. A layer thickness of the optical waveguide 14a is set so that this opposing relationship may be satisfied. Layer thicknesses of the optical waveguides 14b and 14c are also set so that this opposing relationship may be satisfied.

Further, an optical axis of the optical signal emitted by the light emitting portion 11a is parallel to an optical axis of the optical signal emitted by the light emitting portion 12a. In addition, the optical axis of the optical signal emitted by the light emitting portion 11a is also parallel to an optical axis of the optical signal emitted by the light emitting portion 13a. At this time, all of the optical axis of the optical signal emitted by the light emitting portion 11a, the optical axis of the optical signal emitted by the light emitting portion 12a, and the optical axis of the optical signal emitted by the light emitting portion 13a exist in the same plane. The plane that these three optical axes form is then parallel to a transmission direction of the optical signal transmitted inside the optical waveguide 14a. This arrangement relationship is satisfied also on a relationship of the optical waveguide 14b to the light emitting portion 11b, the light emitting portion 12b, and the light emitting portion 13b. In addition, this arrangement relationship is satisfied also on a relationship of the optical waveguide 14c to the light emitting portion 11c, the light emitting portion 12c, and the light emitting portion 13c.

In the above configuration, the optical signal with the wavelength of λ1 emitted by the light emitting portion 11a of the surface light emitting element array 11 according to the control signal from the external source is coupled into an end face of the opposing optical waveguide 14a, and is transmitted through the core portion of the optical waveguide 14a. The optical signal with the wavelength of λ2 emitted by the light emitting portion 12a of the surface light emitting element array 12 according to the control signal from the external source is also coupled into the end face of the opposing optical waveguide 14a, and is transmitted through the core portion of the optical waveguide 14a. Further, the optical signal with the wavelength of λ3 emitted by the light emitting portion 13a of the surface light emitting element array 13 according to the control signal from the external source is also coupled into the end face of the opposing optical waveguide 14a, and is transmitted through the core portion of the optical waveguide 14a. As a result of this, the optical waveguide 14a can perform wavelength multiplex transmission of the optical signals superimposed by three times at the maximum according to the control signal from the external source.

In a manner similar to that, the respective optical signals emitted by the light emitting portion 11b, the light emitting portion 12b, and the light emitting portion 13b, are coupled into the opposing optical waveguides 14b. In a manner completely similar to that, the respective optical signals emitted by the light emitting portion 11c, the light emitting portion 12c, and the light emitting portion 13c, are coupled into the opposing optical waveguides 14c. The coupled optical signals is transmitted through the optical waveguide, and as a result of that, in the optical waveguides 14a through 14c, wavelength multiplex transmission of the optical signals superimposed by three times at the maximum may be achieved according to the control signal from the external source.

In the respective three optical waveguides 14a, 14b and 14c, wavelength multiplex transmission of the optical signals superimposed by three times at the maximum may be achieved according to the control signal from the external source. Therefore, as for the whole wavelength multiplexing device 10, it is possible to perform wavelength multiplex transmission of the optical signals superimposed by nine times at the maximum.

Thus, according to the wavelength multiplexing device 10 of the first embodiment, it comprises the emitter capable of independently emitting at least two optical signals for at least two kinds of wavelength, respectively, and the transmitter which includes a plurality of optical waveguides, and is capable of coupling optical signals with the same wavelength among the optical signals emitted by the emitter into the different optical waveguides and independently transmitting the coupled optical signals, respectively. According to a configuration described above, without using the light emitting portion for emitting the optical signals with the wavelengths, all of which are different, the wavelength multiplexing device can transmit the superimposed optical signals, the number of which is more than that of wavelengths, as wavelength multiplex.

In addition, according to the first embodiment, the two light emitting portions 11a and 11b which oscillate the optical signals with the same wavelength of λ1 are arranged on the integrally formed element. Herein, since both of the light emitting portion 11a and the light emitting portion 11b oscillate the optical signals with the same wavelength of λ1, a structure of the light emitting portion 11a is the same as that of the light emitting portion 11b. In addition, the two light emitting portions 12a and 12b which oscillate the optical signals with the same wavelength of λ2 are arranged on the integrally formed element. Similarly, since both of the light emitting portion 12a and the light emitting portion 12b oscillate the optical signals with the same wavelength of λ2, a structure of the light emitting portion 12a is the same as that of the light emitting portion 12b.

From a viewpoint of manufacturing, a configuration of arranging the light emitting portions which have the same structure on the integrally formed element has fewer manufacturing processes as compared with a configuration of arranging the light emitting portions which have different structures, so that excellent productivity is provided, thereby making it possible to achieve low cost manufacturing. Therefore, according to the first embodiment, it is possible to provide the wavelength multiplexing device 10 in excellent productivity at a low cost.

Moreover, according to the first embodiment, in addition to the above configuration, the first surface light emitting element array 11 having the light emitting portion 11a is provided as the surface light emitting element separated from the second surface light emitting element array 12 having the light emitting portion 12a. Since the light emitting portion 11a and the light emitting portion 12a oscillate the optical signals with wavelengths different from each other, the structure of the light emitting portion 11a is different from that of the light emitting portion 12a. Since the wavelength multiplexing device 10 is not required to form the light emitting portions with different structures on the same element like this, processes for manufacturing the element can further be simplified. Therefore, according to the above configuration, the wavelength multiplexing device 10 can be provided in further excellent productivity at a low cost.

Further, according to the first embodiment, all of the optical waveguides 14a through 14c are the same. Therefore, commonality of the optical waveguide is achieved, so that productivity of the optical waveguide 14 formed by stacking these can be increased. The wavelength multiplexing device 10 can therefore be provided in further excellent productivity at a low cost.

Further, according to the wavelength multiplexing device 10, in addition to the above configuration, an approximately central position of the edge portion of the optical waveguide 14a is opposed to the light emitting portion 11a, the light emitting portion 12a, and the light emitting portion 13a. Similarly, an approximately central position of the edge portion of the optical waveguide 14b is opposed to the light emitting portion 11b, the light emitting portion 12b, and the light emitting portion 13b. Similarly, an approximately central position of the edge portion of the optical waveguide 14c is opposed to the light emitting portion 11c, the light emitting portion 12c, and the light emitting portion 13c. In other words, according to the first embodiment, the optical signal that each light emitting portion oscillates can directly be coupled to the optical waveguide, so that a configuration using an optical coupler, a condenser lens or the like for coupling is not required. The wavelength multiplexing device 10 can therefore be provided in further excellent productivity at a low cost.

Incidentally, the optical waveguide 14 is not limited to the illustrated dimension, but may be larger or smaller than that, as far as it has a dimension capable of coupling the optical signal from each light emitting portion thereinto. In particular, the optical waveguide 14 may be configured so as to have flexibility by using a resin or the like as a material. By providing the flexibility to the optical waveguide, it is possible to bend the transmission line, so that arrangement flexibility of the transmission line is improved, thereby making it possible to use the wavelength multiplexing device for connection between boards in a compact device.

### Second Embodiment

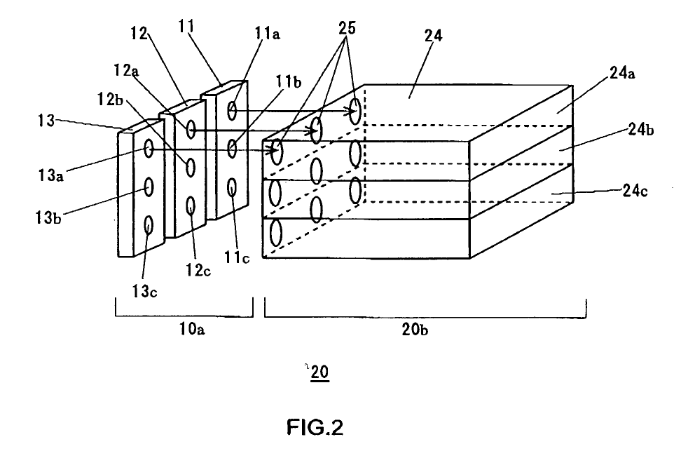

FIG. 2 is a schematic diagram showing a configuration of a wavelength multiplexing device 20 according to a second embodiment. In FIG. 2, the wavelength multiplexing device 20 comprises an emitter 10a and a transmitter 20b. The emitter 10a includes a surface light emitting element array 11, a surface light emitting element array 12, and a surface light emitting element array 13. The transmitter 10b includes an optical waveguide 24. Incidentally, in FIG. 2, the same reference numeral is given to the same configuration as that of the wavelength multiplexing device 10 of first embodiment. In addition, in the second embodiment, description of the same configuration as that of the first embodiment explained above will be omitted, and will be made only of a portion different from that.

The optical waveguide 24 is formed by stacking three optical waveguides 24a through 24c which have the same configuration independent of each other, and comprises almost the same configuration as that of the optical waveguide 14 of the first embodiment. However, the optical waveguide 24 is different in that a lens 25 is formed as condensing portion in a position where the optical signals emitted by all light emitting portions enter. The lens 25 is a convex lens. Each lens 25 converts into a diverging light or a convergence light the optical signal entering from each light emitting portion as a diverging light, and couples it into a corresponding optical waveguide. Therefore, loss of the optical signal at the end face of the optical waveguide can be reduced.

Thus, according to the second embodiment, since the lens 25 is formed in the end portion on an incident side of the optical waveguide 24, coupling efficiency of the light entering the optical waveguide 24 may be improved.

Incidentally, the lens may be formed in an end portion on the exiting side. In this case, coupling efficiency of the light on the exiting side may be improved. In addition, the lenses may be provided on both of the incident side and the exiting side.

Moreover, as the condensing portion, a rod lens and a diffracted type lens which have a refractive index distribution may be provided instead of the convex lens.

### Third Embodiment

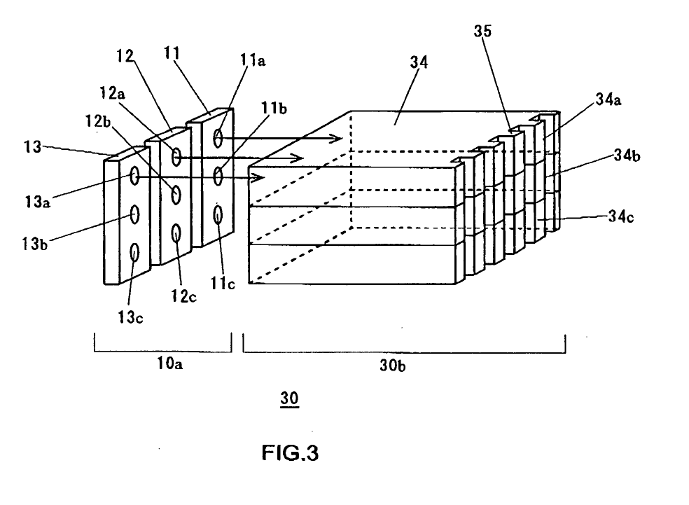

FIG. 3 is a schematic diagram showing a configuration of a wavelength multiplexing device 30 according to a third embodiment. In FIG. 3, the wavelength multiplexing device 30 comprises the emitter 10a and a transmitter 30b. The emitter 10a includes a surface light emitting element array 11, a surface light emitting element array 12, and a surface light emitting element array 13. Transmission portion 30b includes an optical waveguide 34. Incidentally, in FIG. 3, the same reference numeral is given to the same configuration as that of the wavelength multiplexing device 10 of first embodiment. Moreover, in the third embodiment, description of the same configuration as that of the first embodiment explained above will be omitted, and will be made only of a portion different from that.

The optical waveguide 34 is formed by stacking three optical waveguides 34a through 34c which have the same configuration independent of each other, and comprises almost the same configuration as that of the optical waveguide 14 of the first embodiment. However, the optical waveguide 34 is different in that a diffracting optical element 35 is formed in an edge surface on an exiting side.

The diffracting optical element 35 selectively deflects the wavelength of the optical signal from the optical waveguide 14. The diffracting optical element 35 is designed so that diffraction efficiency of primary diffracted light components deflected by diffraction to the wavelengths of λ1 through λ3 may become to a maximum, and deflection directions may be different according to the wavelengths of λ1 through λ3. At this time, the diffracting optical element 35 has power for the strongest deflection to the optical signal with the wavelength of λ1. Conversely, it has power for the weakest deflection to the optical signal with the wavelength of λ3. Therefore, after the superimposed optical signals transmit the diffracting optical element 35, the optical signal with the wavelength of λ1 is changed most significantly in direction, but the optical signal with the wavelength of λ3, is hardly changed in direction.

Thus, the optical signals can be separated from the superimposed optical signals for every wavelength. Also regarding to the optical waveguides 34b and 34c, the optical signals can similarly be separated for every wavelength by the diffracting optical element 35. In this case, for example, if photo detectors are arranged so as to correspond to the optical signals separated for every wavelength, the optical signal can be detected for every wavelength.

Incidentally, wavelength transmission property of the diffracting optical element 35 is not limited to the third embodiment. For example, it may be designed so as to make only an optical signal with a specific wavelength to be transmitted without giving power for deflection, or make the optical signal with the specific wavelength to be cut without transmitting.

Thus, according to the third embodiment, since the diffracting optical element 35 is formed in the end portion on the exiting side of the optical waveguide 34 as wavelength selection portion, it is possible to deflect the optical signal with the selected specific wavelength among the optical signals exiting from the optical waveguide 34 and make it exit therefrom.

### Fourth Embodiment

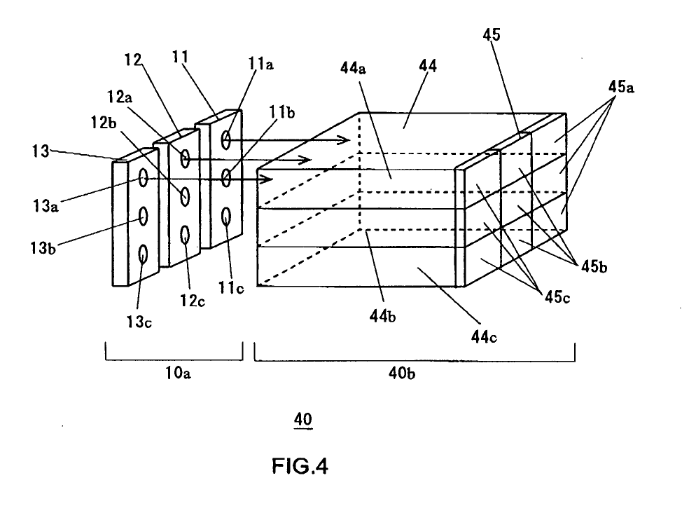

FIG. 4 is a schematic diagram showing a configuration of a wavelength multiplexing device 40 according to a fourth embodiment. In FIG. 4, the wavelength multiplexing device 40 comprises the emitter 10a and a transmitter 40b. The emitter 10a includes the surface light emitting element array 11, the surface light emitting element array 12, and the surface light emitting element array 13. Transmission portion 40b includes an optical waveguide 44. Incidentally, in FIG. 4, the same reference numeral is given to the same configuration as that of the wavelength multiplexing device 10 of first embodiment. Moreover, in the fourth embodiment, description of the same configuration as that of the first embodiment explained above will be omitted, and will be made only of a portion different from that.

The optical waveguide 44 is formed by stacking three optical waveguides 44a through 44c which have the same configuration independent of each other, and comprises almost the same configuration as that of the optical waveguide 14 of the first embodiment. However, the optical waveguide 44 is different in that a filter 45 is formed as wavelength selection portion in an edge surface on an exiting side.

The filter 45 selectively transmits a wavelength of the optical signal from the optical waveguide 14. In the edge surface on the exiting side of the optical waveguides 44a through 44c, a filter 45a, a filter 45b, and a filter 45c are provided. The filter 45a only transmits the optical signal with the wavelength of λ1, and absorbs the optical signals with the wavelengths of λ2 and λ3. The filter 45b only transmits the optical signal with the wavelength of λ2, and absorbs the optical signals with the wavelengths of λ1 and λ3. The filter 45c only transmits the optical signal with the wavelength of λ3, and absorbs the optical signals with the wavelengths of λ1 and λ2. The optical signals transmitted through the optical waveguide 44a are superimposed by three times at the maximum with the optical signals with the wavelengths of λ1, λ2, and λ3. After transmitting through the filter 45a, the superimposed optical signals will be filtered into the only optical signal with the wavelength of λ1. Similarly, the superimposed optical signals will be filtered into the only optical signal with the wavelength of λ2 after transmitting through the filter 45b. In addition, the superimposed optical signals will be filtered into only the optical signal with the wavelength of λ3 after transmitting through the filter 45c. Consequently, the desired optical signal can be separated from the superimposed optical signals for every wavelength. Also regarding to the optical waveguides 44b and 44c, the desired optical signal can similarly be separated from the superimposed optical signals for every wavelength by the filter 45.

Thus, according to the fourth embodiment, since the filter 45 is arranged as wavelength selection portion in the edge surface on the exiting side of the optical waveguide 44, it is possible to separate the desired optical signal from the superimposed optical signals for every wavelength after transmitting through the filters. In this case, for example, if photo detectors are arranged so as to correspond to the optical signals separated for every wavelength, the optical signal can be detected for every wavelength. Incidentally, wavelength transmission property of the filter 45 is not limited to the fourth embodiment, but can be designed according to the desired optical signal. For example, when only specific wavelength is desired to be separated from the optical signals superimposed by three times at the maximum, what is necessary is just to design a filter for transmitting the only optical signal with a wavelength to be separated. That makes it possible to further increase a function of the wavelength multiplexing device.

Thus, according to the fourth embodiment, since the filter 45 is formed in the end portion on the exiting side of the optical waveguide 44, it is possible to make the optical signal with the selected specific wavelength among the optical signals exiting from the optical waveguide 44 exit.

### Fifth Embodiment

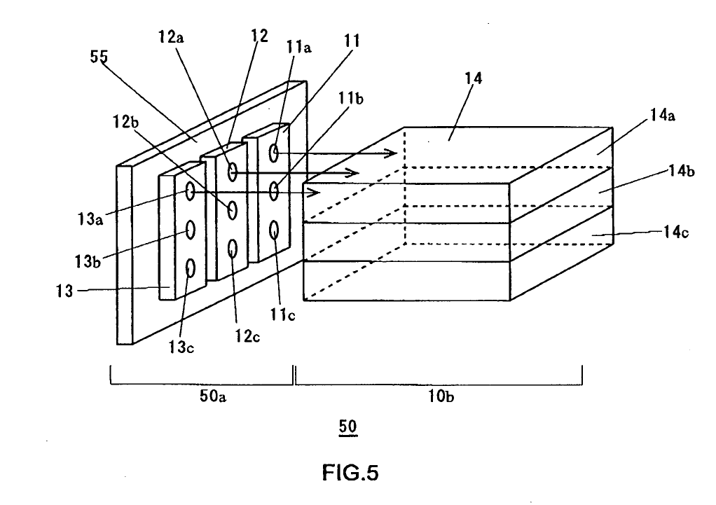

FIG. 5 is a schematic diagram showing a configuration of a wavelength multiplexing device 50 according to a fifth embodiment. In FIG. 5, the wavelength multiplexing device 50 comprises an emitter 50a and the transmitter 10b. The emitter 50a includes the surface light emitting element array 11, the surface light emitting element array 12, the surface light emitting element array 13, and a substrate 55. The transmitter 10b includes the optical waveguide 14. Incidentally, in FIG. 5, the same reference numeral is given to the same configuration as that of the wavelength multiplexing device 10 of first embodiment. Moreover, in the fifth embodiment, description of the same configuration as that of the first embodiment explained above will be omitted, and will be made only of a portion different from that.

The surface light emitting element arrays 11 through 13 are mounted on the same substrate 55. Hence, it is possible to unitize a whole light emitting portion on the occasion of an assembly, and perform a coupling adjustment of the optical waveguide 14 to the unit. Therefore, according to the above configuration, the assembly and the adjustment of the wavelength multiplexing device 50 can be performed with ease, thereby making it possible to improve productivity.

Meanwhile, a thermal expansion coefficient of the substrate 55 is almost the same value as that of the optical waveguides 54a through 54c of the optical waveguide 14. Thus, when the thermal expansion coefficient of the substrate 55 is made to be approximately the same as that of the optical waveguides 54a through 54c, the amount of change in position to a change in temperature of the surface light emitting element arrays 11 through 13 mounted on the substrate 55 becomes relatively equal to the amount of change in position of the optical waveguide 54. Therefore, reliability of the wavelength multiplexing device 50 can be improved.

### Sixth Embodiment

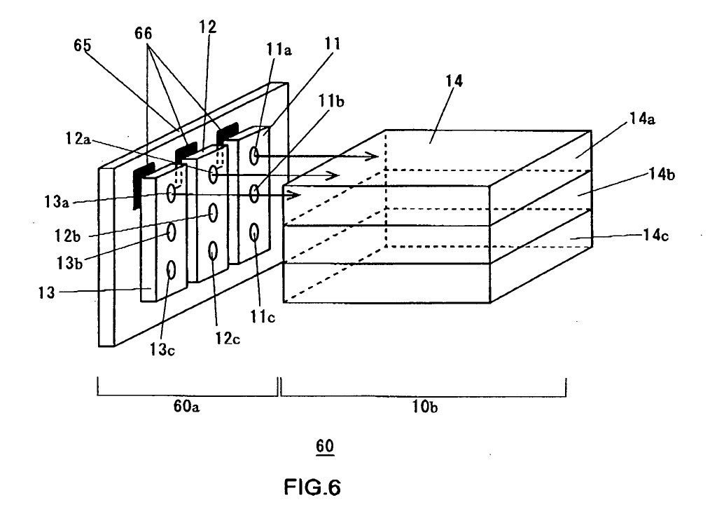

FIG. 6 is a schematic diagram showing a configuration of a wavelength multiplexing device 60 according to a sixth embodiment. In FIG. 6, the wavelength multiplexing device 60 comprises an emitter 60a and the transmitter 10b. The emitter 60a includes the surface light emitting element array 11, the surface light emitting element array 12, the surface light emitting element array 13, and a substrate 65. The transmitter 10b includes the optical waveguide 14. Incidentally, in FIG. 6, the same reference numeral is given to the same configuration as that of the wavelength multiplexing device 10 of first embodiment. Moreover, in the sixth embodiment, description of the same configuration as that of the first embodiment explained above will be omitted, and will be made only of a portion different from that.

According to the wavelength multiplexing device 60, in a matter similar to the above-mentioned wavelength multiplexing device 50, the surface light emitting element arrays 11 through 13 are mounted on the same substrate 65. At this time, a marker 66 for specifying a mounting position of the surface light emitting element arrays 11 through 13 is formed on the substrate 65. The marker 66 may be, for example a key type. This marker 66 may actually be formed with a stamp or the like on the substrate 65, or may be formed in a physical manner (stamping or the like) or a chemical manner (etching or the like) in a stage of manufacturing the substrate.

If the surface light emitting element arrays 11 through 13 are mounted after forming the marker 66 on the substrate 65, it is possible to position the surface light emitting element arrays 61 through 63 at desirable accuracy, thereby making it possible to remarkably contribute to improving in productivity.

Incidentally, the marker 66 may be formed so as to be used not only for positioning the surface light emitting element arrays 11 through 13 mounted on the substrate 65, but for positioning the optical waveguide 14 with respect to the substrate 65.

According to the above configuration, a relative positioning of each of the surface light emitting element arrays 11 through 13 or the optical waveguide 14 can be performed with ease by the marker 66 formed on the substrate 65. Therefore, the assembly and the adjustment of the wavelength multiplexing device 60 can be performed with ease.

### Seventh Embodiment

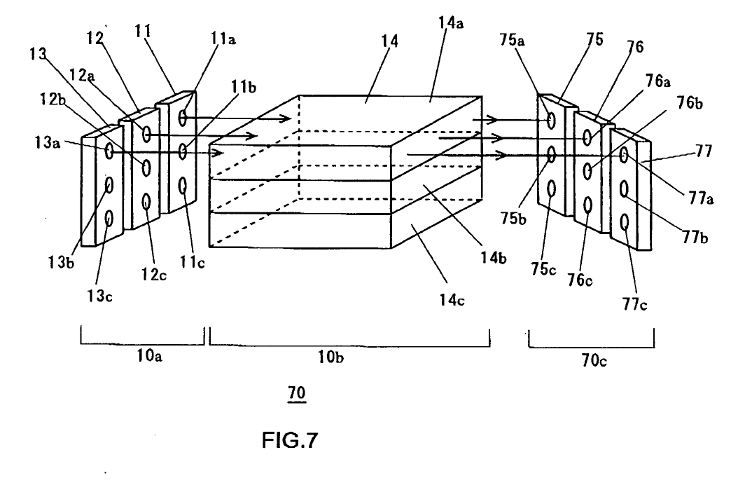

FIG. 7 is a schematic diagram showing a configuration of a wavelength multiplexing device 50 according to a seventh embodiment. In FIG. 7, the wavelength multiplexing device 70 comprises the emitter 10a, the transmitter 10b, and a detector 70c. The emitter 10a includes the surface light emitting element array 11, the surface light emitting element array 12 and the surface light emitting element array 13. The transmitter 10b includes the optical waveguide 14. The detector 10a includes a surface photo detector array 75, a surface photo detector array 76, and a surface photo detector array 77. Incidentally, in FIG. 7, the same reference numeral is given to the same configuration as that of the wavelength multiplexing device 10 of first embodiment. Moreover, in the seventh embodiment, description of the same configuration as that of the first embodiment explained above will be omitted, and will be made only of a portion different from that.

The surface photo detector array 75 comprises a photo detector 75a, a photo detector 75b, and a photo detector 75c. The photo detectors 75a through 75c are integrally formed along one direction on the same element. The photo detector 75a absorbs the optical signal with the wavelength of λ1 to be detected as the optical signal. The photo detector 75b absorbs the optical signal with the wavelength of λ1 independently of the photo detector 75a to be detected as the optical signal. The photo detector 75c absorbs the optical signal with the wavelength of λ1 independently of the photo detector 75a and the photo detector 75b to be detected as the optical signal. Thus, all light signals that the photo detectors 75a through 75c absorb have the optical signal with the wavelength of λ1. Similarly, the surface photo detector array 76 comprises a photo detector 76a, a photo detector 76b, and a photo detector 76c. The photo detectors 76a through 76c absorb and detect the optical signal with the wavelength of λ2. Moreover, in a manner similar to that, the surface photo detector array 77 comprises a photo detector 77a, a photo detector 77b, and a photo detector 77c. The photo detectors 77a through 77c absorb and detect the optical signal with the wavelength of λ3.

Each of the photo detectors is a photodiode. As for the photo detectors 75a through 75c for absorbing and detecting the optical signal with the wavelength of λ1, an optical thin film which does not transmit the optical signals with the wavelengths of λ2 and λ3 is formed on an incident side of the photodiode. As for the photo detectors 76a through 76c for absorbing and detecting the optical signal with the wavelength of λ2, an optical thin film which does not transmit the optical signals with the wavelengths of λ1 and λ3 is formed on an incident side of the photodiode. As for the photo detectors 77a through 77c for absorbing and detecting the optical signal with the wavelength of λ3, an optical thin film which does not transmit the optical signals with the wavelengths of λ1 and λ2 is formed on an incident side of the photodiode. Meanwhile, a spacing between the photo detector 75a and the photo detector 75b is almost equal to a spacing between the photo detector 75b and the photo detector 75c.

The edge portion of the optical waveguide 14a is opposed to the photo detector 75a, the photo detector 76a, and the photo detector 77a. In addition, the edge portion of the optical waveguide 14b is opposed to the photo detector 75b, the photo detector 76b, and the photo detector 77b. Moreover, the edge portion of the optical waveguide 14c is opposing to the photo detector 75c, the photo detector 76c, and the photo detector 77c.

Further, an optical axis of the optical signal which enters the photo detector 75a is parallel to that of the optical signal which enters the photo detector 76a. Moreover, the optical axis of the optical signal which enters the photo detector 75a is parallel to that of the optical signal which enters the photo detector 77a. At this time, all of the optical axis of the optical signal which enters the photo detector 75a, the optical axis of the optical signal which enters the photo detector 76a, and the optical axis of the optical signal which enters the photo detector 77a exist in the same plane. The plane that these three optical axes form is then parallel to a transmission direction of the optical signal transmitted inside the optical waveguide 14a. This arrangement relationship is satisfied also on a relationship of the optical waveguide 14b to the photo detector 75b, the photo detector 76b, and the photo detector 77b. Moreover, this arrangement relationship is satisfied also on a relationship of the optical waveguide 14c to the photo detector 75c, the photo detector 76c, and the photo detector 77c.

The optical signals exiting from the optical waveguide 14a enter the photo detector 75a, the photo detector 76a, and the photo detector 77a. These optical signals are superimposed by three times at the maximum according to the control signal. Herein, the superimposed optical signals are three, the optical signals with the wavelengths of λ1, λ2, and λ3. At this time, the photo detector 75a detects only the optical signal with the wavelength of λ1 component among the superimposed optical signals. This is because that the photo detector 75a has a characteristic of absorbing the optical signal with the wavelength of λ1. In a manner similar to that, the photo detector 76a detects only the optical signal with the wavelength of λ2 component among the superimposed optical signals. The photo detector 77a detects only the optical signal with the wavelength of λ3 component among the superimposed optical signals. Consequently, it is possible to separate and detect an individual optical signal component from the optical signals which are transmitted as the wavelength multiplex signal. In a manner completely similar to that, the optical signals exiting from the optical waveguide 14b and from the optical waveguide 14c are separated and detected into individual optical signal components, respectively. Thus, according to the seventh embodiment, since the photo detectors having the different wavelength absorption characteristics are arranged, without using a diffracting optical element and a filter, a desired wavelength component can be detected from the optical signals transmitted as the wavelength multiplex signal according to a simple configuration.

Moreover, in the wavelength multiplexing device 70, the first surface photo detector array 75 having the photo detector 75a is used as a surface photo detector separated from the second surface photo detector array 76 having the light emitting portion 76a. Since the photo detector 75a and the photo detector 76a absorb the optical signals with the wavelengths different from each other, a structure of the photo detector 75a is different from that of the photo detector 76a. Since the wavelength multiplexing device 70 is not required to form the light emitting portions with different structures on the same element like this, processes for manufacturing the element can further be simplified. Therefore, according to the above configuration, the wavelength multiplexing device 70 can be provided in further excellent productivity at a low cost.

Further, in the wavelength multiplexing device 70, an approximately central position of the edge portion of the optical waveguide 14a is opposed to the photo detector 75a and the photo detector 76a. Similarly, an approximately central position of the edge portion of the optical waveguide 14b is opposed to the photo detector 75b and the photo detector 76b. In other words, the wavelength multiplexing device 70 can directly couple the optical signal exiting from the optical waveguide into the photo detector, so that a configuration using an optical coupler, a condenser lens or the like for coupling is not required. Therefore, the wavelength multiplexing device 70 can be provided in further excellent productivity at a low cost.

Incidentally, the surface photo detector arrays 75, 76, and 77 may be mounted on the same substrate, such as the substrate 55 on which the surface light emitting element arrays 11 through 13 are mounted as explained in the wavelength multiplexing device 50 shown in FIG. 5. The surface photo detector arrays 75 through 77 are mounted on the same substrate, so that manufacturing and adjustment can be performed with ease, thereby making it possible to achieve an improvement in productivity of the wavelength multiplexing device 70.

### Eighth Embodiment

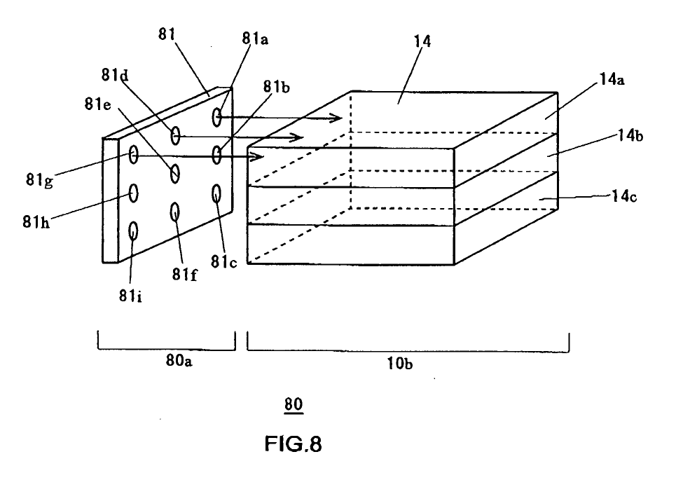

FIG. 8 is a schematic diagram showing a configuration of a wavelength multiplexing device 80 according to an eighth embodiment. In FIG. 8, the wavelength multiplexing device 80 comprises an emitter 80a and the transmitter 10b. The emitter 80a includes a surface light emitting element array 81. The transmitter 10b includes the optical waveguide 14. Incidentally, in FIG. 8, the same reference numeral is given to the same configuration as that of the wavelength multiplexing device 10 of first embodiment. Moreover, in the eighth embodiment, description of the same configuration as that of the first embodiment explained above will be omitted, and will be made only of a portion different from that.

The surface light emitting element array 81 includes nine light emitting portions 81a through 81i which are integrally formed on the same element and arranged on a two-dimensional lattice. The light emitting portions 81a through 81c are integrally formed along one direction. The light emitting portion 81a oscillates an optical signal with the wavelength of λ1 as a diverging light based on a control signal from the external source. The light emitting portion 81b oscillates an optical signal with the wavelength of λ1 as a diverging light independently of the light emitting portion 81a based on a control signal from the external source. The light emitting portion 81c oscillates an optical signal with the wavelength of λ1 as a diverging light independently of the light emitting portion 81a and the light emitting 81b based on a control signal from the external source. Thus, all light signals that the light emitting portions 81a through 81c oscillate have the wavelength of λ1. Meanwhile, a spacing between the light emitting portion 81a and the light emitting portion 81b is almost equal to a spacing between the light emitting portion 81b and the light emitting portion 81c.

Moreover, the light emitting portions 81d through 81f are integrally formed along one direction. The light emitting portion 81d oscillates an optical signal with the wavelength of λ2 as a diverging light completely independently of the other light emitting portions based on a control signal from the external source. The light emitting portion 81e oscillates an optical signal with the wavelength of λ2 as a diverging light completely independently of the other light emitting portions based on a control signal from the external source. The light emitting portion 81f oscillates an optical signal with the wavelength of λ2 as a diverging light completely independently of the other light emitting portions based on a control signal from the external source. Thus, all light signals that the light emitting portions 81d through 81e oscillate have the wavelength of λ2.

Moreover, the light emitting portions 81g through 81i are integrally formed along one direction. The light emitting portion 81g oscillates an optical signal with the wavelength of λ3 as a diverging light completely independently of the other light emitting portions based on a control signal from the external source. The light emitting portion 81h oscillates an optical signal with the wavelength of λ3 as a diverging light completely independently of the other light emitting portions based on a control signal from the external source. The light emitting portion 81i oscillates an optical signal with the wavelength of λ3 as a diverging light completely independently of the other light emitting portions based on a control signal from the external source. Thus, all light signals that the light emitting portions 81g through 81i oscillate have the wavelength of λ3.

The edge portion of the optical waveguide 14a is opposed to the light emitting portion 81a, the light emitting portion 82d, and the light emitting portion 81g. The edge portion of the optical waveguide 14b is also opposed to the light emitting portion 81b, the light emitting portion 81e, and the light emitting portion 81h. Moreover, the edge portion of the optical waveguide 14c is also opposed to the light emitting portion 81c, the light emitting portion 81f, and the light emitting portion 81i. A layer thickness of the optical waveguide 14a is set so that this opposing relationship may be satisfied.

Further, an optical axis of the optical signal emitted by the light emitting portion 81a is parallel to an optical axis of the optical signal emitted by the light emitting portion 81d. In addition, the optical axis of the optical signal emitted by the light emitting portion 81a is parallel to an optical axis of the optical signal emitted by the light emitting portion 81g. At this time, all of the optical axis of the optical signal emitted by the light emitting portion 81a, the optical axis of the optical signal emitted by the light emitting portion 81d, and the optical axis of the optical signal emitted by the light emitting portion 81g exist in the same plane. The plane that these three optical axes form is then parallel to a transmission direction of the optical signal transmitted inside the optical waveguide 14a. This arrangement relationship is satisfied also on a relationship of the optical waveguide 14b to the light emitting portion 81b, the light emitting portion 81e, and the light emitting portion 81h. In addition, this arrangement relationship is satisfied also on a relationship of the optical waveguide 14c to the light emitting portion 81c, the light emitting portion 81f, and the light emitting portion 81i.

In the above configuration, the optical signal with the wavelength of λ1 emitted by the light emitting portion 81a according to the control signal from the external source is coupled into the end face of the opposing optical waveguide 14a, and is transmitted through the core portion of the optical waveguide 14a. Moreover, the optical signal with the wavelength of λ2 emitted by the light emitting portion 81d according to the control signal from the external source is coupled into the end face of the opposing optical waveguide 14a, and is transmitted through the core portion of the optical waveguide 14a. Further, the optical signal with the wavelength of λ3 emitted by the light emitting portion 81g according to the control signal from the external source is coupled into the end face of the opposing optical waveguide 14a, and is transmitted through the core portion of the optical waveguide 14a. Therefore, the optical waveguide 14a can perform wavelength multiplex transmission of the optical signals superimposed by three times at the maximum according to the control signal from the external source.

In a manner similar to that, the respective optical signals emitted by the light emitting portion 81b, the light emitting portion 81e, and the light emitting portion 81h, are coupled into the opposing optical waveguides 14b. In a manner completely similar to that, the respective optical signals emitted by the light emitting portion 81c, the light emitting portion 81f, and the light emitting portion 81i, are coupled into the opposing optical waveguides 14c. The coupled optical signals are transmitted through the optical waveguide, as a result of that, in the optical waveguides 14a through 14c, wavelength multiplex transmission of the optical signals superimposed by three times at the maximum may be achieved according to the control signal from the external source.

In the respective three optical waveguides 14a, 14b and 14c, wavelength multiplex transmission of the optical signals superimposed by three times at the maximum may be achieved according to the control signal from the external source. Therefore, as for the whole wavelength multiplexing device 80, it is possible to perform wavelength multiplex transmission of the optical signals superimposed by nine times at the maximum.

Thus, according to the wavelength multiplexing device 80 of the eighth embodiment, it comprises the emitter capable of independently emitting at least two optical signals for at least two kinds of wavelength, respectively, and the transmitter including a plurality of optical waveguides, and capable of coupling optical signals with the same wavelength among the optical signals emitted by the emitter into the different optical waveguides and independently transmitting the coupled optical signals, respectively. According to a configuration described above, without using the light emitting portion for emitting the optical signals with the wavelengths, all of which are different, the wavelength multiplexing device can transmit the superimposed optical signals, the number of which is more than that of wavelengths, as wavelength multiplex.

Moreover, in the eighth embodiment, the two light emitting portions 81a and 81b which oscillate the optical signals with the same wavelength of λ1 are arranged on the integrally formed element. Herein, since both of the light emitting portion 81a and the light emitting portion 81b oscillate the optical signals with the same wavelength of λ1, a structure of the light emitting portion 81a is the same as that of the light emitting portion 81b. Moreover, the two light emitting portions 81d and 81e which oscillate the optical signals with the same wavelength of λ2 are arranged on the integrally formed element. Similarly, since both of the light emitting portion 81d and the light emitting portion 81e oscillate the optical signals with the same wavelength of λ2, a structure of the light emitting portion 81d is the same as that of the light emitting portion 81e.

From a viewpoint of manufacturing, a configuration of arranging the light emitting portions which have the same structure on the integrally formed element has fewer manufacturing processes as compared with a configuration of arranging the light emitting portions which have completely different structures, so that excellent productivity is provided, thereby making it possible to achieve low cost manufacturing. Therefore, according to the eighth embodiment, it is possible to provide the wavelength multiplexing device in excellent productivity at a low cost.

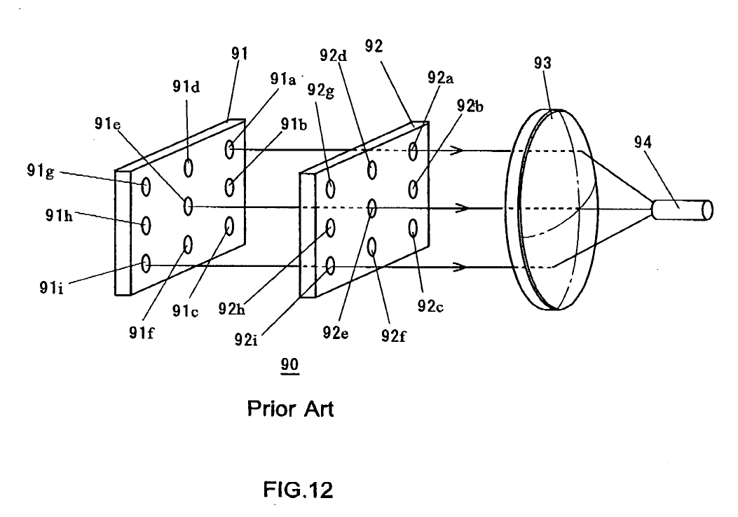

Moreover, in the eighth embodiment, all of the light emitting portions are integrally formed on the same surface light emitting element array 81. Since the light emitting portion 81a and the light emitting portion 81d oscillate the optical signals with wavelengths different from each other, the structure of the light emitting portion 81a is different from that of the light emitting portion 81d. However, in comparison with a case where the surface light emitting elements with the emission wavelengths, all of which are different, are manufactured, since the number of emission wavelength is reduced, the surface light emitting element array 81 can be manufactured with ease. Furthermore, as for the surface light emitting element array 81, since a relative positioning relationship between the light emitting portions is determined at the time of manufacturing, the positioning between the light emitting portion and the optical waveguide can be performed with ease. For this reason, in the eighth embodiment, in comparison with a case of the prior wavelength multiplexing device shown in FIG. 12, it is possible to reduce a cost needed for assembly adjustment. The wavelength multiplexing device 80 can therefore be provided in further excellent productivity at a low cost.

### Ninth Embodiment

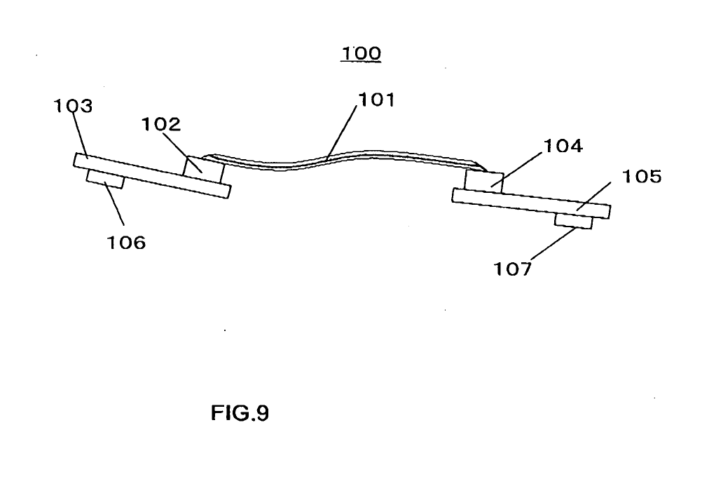

FIG. 9 is a side view of an optical transmission module according to a ninth embodiment. According to the optical transmission module 100 of the ninth embodiment, it includes a transmitter 101, an emitter 102, a first sub-board 103, a detector 104, and a second sub-board 105. The transmitter 101, the emitter 102, and the detector 104 have the same configuration as that of the wavelength multiplexing device 70 shown in FIG. 7, and correspond to the wavelength multiplexing device. The first sub-board 103 mounts the emitter 102 which mounts predetermined elements including the surface light emitting element arrays 11 through 13. The first sub-board 103 has an electric connector 106. The second sub-board 105 mounts the detector 104 which mounts predetermined elements including the surface photo detector arrays 75 through 77. The second sub-board 105 has an electric connector 107. Moreover, the first sub-board 103 is electrically connected to the second sub-board 105 with an electric interconnection. The electric interconnection is used for a voltage supply from a power supply. The emitter 102 and the detector 104 are mounted on the respective sub-boards using a flip chip mounting method or a wire bonding method. The emitter 102 and the detector 104 are fixed to both ends of the transmitter 101 with an adhesive transparent to wavelengths to be used. The transmitter 101 is a stacked type optical waveguide made from a resin provided with flexibility.

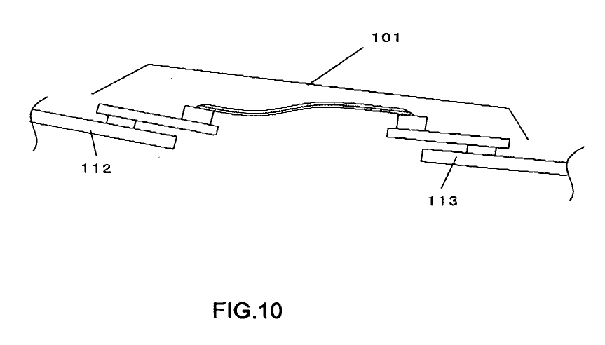

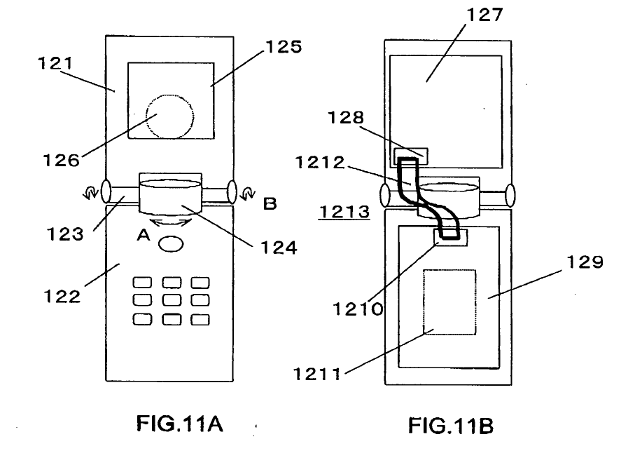

FIG. 10 is a side view showing a usage example of the optical transmission module according to the ninth embodiment. In FIG. 11, the optical transmission module 100 connects two main boards 112 and 113. The optical transmission module 100 is attached to the main boards using electric connectors provided to the respective sub-boards, respectively. The main board 112 and the main board 113 are electrically connected via each sub-board with the light signal transmitted through the transmitter 101 included in the optical transmission module 100. The optical transmission module 100 electrically connects the first sub-board 103 to the second sub-board 105 with the light signal which is transmitted by an optical waveguide.

Incidentally, in the optical transmission module 100, both of the surface photo detector array and the light emitting element array may be mounted on the first sub-board 103 and the second sub-board 105, respectively. According to the configuration like this, the light signal which exits from the surface light emitting element array of the first sub-board 103 may be led to the surface photo detector array of the second sub-board 105, and the light signal which exits from the surface light emitting element array of the second sub-board 104 may conversely be led to the surface photo detector of the first sub-board 103, thereby making it possible to achieve bidirectional communication.

### 10th Embodiment

FIG. 11A is an external view of a portable telephone device according to a 10th embodiment. The portable telephone device according to the 10th embodiment is basically similar to a typical folding type cellular phone, and an upper housing 121 and a lower housing 122 are mechanically connected by a hinge portion 123 and a hinge portion 124. The portable telephone device can be used with folding the hinge portion 123 in an A direction. Moreover, the portable telephone device can be used with being rotated in a B direction by the hinge portion 124. The upper housing 121 has a display 125 which is a liquid crystal display unit. A plurality of displays 125 may be provided to the upper housing 121. Moreover, an organic electro-luminescence display device or the like may be used as the display 125. A camera portion 126 is arranged in a backside surface of the upper housing 121. A plurality of camera portions 126 may be provided to the upper housing 121, and may be provided to the lower housing 122. The lower housing 122 includes a keyboard input unit that an operator operates.

FIG. 11B is a view of an internal configuration of the portable telephone device according to the 10th embodiment. The upper housing 121 includes a first main board 127 and a first sub-board 128 connected thereto via an electric connector (not shown) inside. Moreover, the lower housing 122 includes a second main board 129 and a second sub-board 1210 inside. The second main board 129 is electrically connected to a power supply 1211. The first sub-board 128 is connected to the second sub-board 129 with an optical transmission module 1213. The optical transmission module 1213 is common to that explained in the ninth embodiment, and connects the first sub-board 128 to the second sub-board 1210 with the light signal which is transmitted by the transmitter 1212.

Since the transmitter 1212 has bending property against a sufficient bending and twist, also when the upper housing 121 is folded to the lower housing 122 by the hinge portion 123, the light signal can be transmitted without losses, thereby making it possible to achieve a high-speed transmission. Therefore, the portable telephone device of the 10th embodiment is effective for achieving multifunction and high-performance of a device consisting mainly of a display and a camera portion.

Incidentally, the device may be applied to portable devices, such as a notebook type personal computer and a PDA (Personal Digital Assistance) without being limited to the portable telephone device.

### Other Embodiment

Incidentally, a novel idea disclosed herein may suitably be changed without being limited to the above embodiments. For example, although a case where there have been three kinds of emission wavelength has been described in each embodiment, a configuration where there are two or four kinds of emission wavelength or the like may also be employed. Moreover, as a matter of course, the number of light emitting portions is not limited to three either, but a configuration having two, or not less than four light emitting portions may also be employed. In this case, the number of laminated layers of the stacked type optical waveguide is determined in accordance with the surface light emitting element array having the maximum number of light emitting portions. Moreover, the number of light emitting portions may be changed for every light emitting element array, such that the number of light emitting portions of one surface light emitting element array is two, the number of light emitting portions of other light emitting element arrays is three, or the like.

Moreover, in each embodiment, although nothing is arranged at all between the surface light emitting element array and the stacked type optical waveguide, optical elements, for example a lens, a diffracting optical element, a mirror, a prism or the like may be arranged. By arranging these elements, flexibility of a layout between the surface light emitting element array and the stacked type optical waveguide may be improved. Coupling efficiency to the optical waveguide may also be improved. Further, even when a spacing between the light emitting portion of the surface light emitting element array is different from a layer thickness of the stacked type optical waveguide, matching can be achieved by the optical element, thereby making it effective. Further, the optical element may similarly be arranged also between the stacked type optical waveguide and each of the surface photo detector array in the seventh embodiment.

Moreover, when the emitter includes a plurality of light emitting element arrays such as the first through seventh embodiments, a spacing between the light emitting portions of one surface light emitting element array may be different from that between the light emitting portions of the other light emitting element array. In this case, when the surface light emitting element array with a larger spacing between the light emitting portions is rotated in a plane perpendicular to the optical axis and is obliquely arranged, the spacing between the light emitting portions may be adjusted.

Moreover, the optical waveguide 14a is not limited to a multimode slab transmission line of step index type formed such that clad portions having a refractive index lower than that of a core portion are disposed on upper and lower sides of the core portion having a predetermined refractive index. It may be a multimode slab transmission line of grated index type where a refractive index gradually decreases from a core portion to a peripheral portion, and may also be a slab transmission line of single mode.

Moreover, the optical waveguide may not be a stacked type, and as far as it has a structure where the optical signals with the same wavelength are not mixed, any structure may be employed. For example, the optical waveguide may be held individually and an air space may be intervened between respective optical waveguides.

The wavelength multiplexing device is suitable for an optical data bus used for an optical transmission system or the like applied to a public correspondence or a computer network, and a signal transmission between devices.

Although description has been made of the novel configuration in detail as mentioned above, the aforementioned discussion is just for the purpose of illustration in all respects, and is not intended to limit the range of the present invention. It is needless to say that various improvements and modifications may be performed, without departing from the scope of the invention.

1. A wavelength multiplexing device, comprising:
an emitter capable of independently emitting at least two optical signals for at least two kinds of wavelength, respectively; and
a transmitter including a plurality of optical waveguides into which the optical signals emitted by the emitter are coupled and which independently transmit the coupled optical signals, respectively,
wherein while coupling optical signals with the same wavelength among the optical signals emitted by the emitter into the optical waveguides different from each other, the transmitter couples optical signals with wavelengths different from each other into a same optical waveguide.

2. The wavelength multiplexing device as claimed in claim 1, wherein the transmitter is a stacked type optical waveguide formed by stacking optical waveguides.

3. The wavelength multiplexing device as claimed in claim 1, wherein the emitter includes
a first surface light emitting element array for independently emitting at least two optical signals with a first wavelength, respectively, and
a second surface light emitting element array for independently emitting at least two optical signals with a wavelength different from the first wavelength, respectively.

4. The wavelength multiplexing device as claimed in claim 3, wherein the emitter includes a substrate for mounting the first surface light emitting element array and the second surface light emitting element array.

5. The wavelength multiplexing device as claimed in claim 4, wherein the substrate has a marker for positioning the first or second surface light emitting element array, or at least one of the optical waveguides with respect to the substrate.

6. The wavelength multiplexing device as claimed in claim 4, wherein a thermal expansion coefficient of the substrate is almost the same as that of at least one of the optical waveguides.

7. The wavelength multiplexing device as claimed in claim 1, wherein the emitter includes
a surface light emitting element array for independently emitting at least two optical signals with the first wavelength, respectively, and independently emitting at least two optical signals with the second wavelength different from the first wavelength, respectively.

8. The wavelength multiplexing device as claimed in claim 1, further comprising:
a detector capable of detecting the optical signal transmitted through the optical waveguide for every wavelength.

9. The wavelength multiplexing device as claimed in claim 8, wherein the detector includes
a first surface photo detector array for detecting at least two optical signals with the first wavelength; and
a second surface photo detector array for detecting at least two optical signals with the second wavelength different from the first wavelength.

10. The wavelength multiplexing device as claimed in claim 1, wherein the transmitter includes
a wavelength selecting portion for separating the exiting optical signals for every wavelength.

11. The wavelength multiplexing device as claimed in claim 10, wherein the wavelength selection portion is a diffracting optical element formed in the optical waveguide.

12. The wavelength multiplexing device as claimed in claim 10, wherein the wavelength selection portion is a filter formed in the optical waveguide.

13. The wavelength multiplexing device as claimed in claim 1, wherein the transmitter includes a condensing portion for coupling entering/exiting optical signals into the transmitter.

14. The wavelength multiplexing device as claimed in claim 13, wherein the condensing portion is a lens formed in the optical waveguide.

15. The wavelength multiplexing device as claimed in claim 1, wherein the optical waveguide has flexibility.

16. An optical transmission module, comprising:
a wavelength multiplexing device for performing wavelength multiplexing of a plurality of optical signals and transmitting them; and
first and second sub-boards connected by the wavelength multiplexing device,
wherein the wavelength multiplexing device includes
an emitter capable of independently emitting at least two optical signals for at least two kinds of wavelength, respectively; and
a transmitter including a plurality of optical waveguides into which the optical signals emitted by the emitter are coupled and which independently transmit the coupled optical signals, respectively,
wherein while coupling optical signals with the same wavelength among the optical signals emitted by the emitter into the optical waveguides different from each other, the transmitter couples optical signals with wavelengths different from each other into a same optical waveguide.

17. The optical transmission module as claimed in claim 16, wherein the transmitter is a stacked type optical waveguide formed by stacking optical waveguides of plane shape.

18. The optical transmission module as claimed in claim 16, wherein the emitter includes
a first surface light emitting element array for independently emitting at least two optical signals with a first wavelength, respectively, and
a second surface light emitting element array for independently emitting at least two optical signals with a wavelength different from the first wavelength, respectively.

19. The optical transmission module as claimed in claim 18, wherein the emitter includes a substrate for mounting the first surface light emitting element array and the second surface light emitting element array.

20. The optical transmission module as claimed in claim 19, wherein the substrate has a marker for positioning the first or second surface light emitting element array, or at least one of the optical waveguides with respect to the substrate.

21. The optical transmission module as claimed in claim 19, wherein a thermal expansion coefficient of the substrate is almost the same as that of at least one of the optical waveguides.

22. The optical transmission module as claimed in claim 16, wherein the emitter includes
a surface light emitting element array for independently emitting at least two optical signals with the first wavelength, respectively, and independently emitting at least two optical signals with the second wavelength different from the first wavelength, respectively.

23. The optical transmission module as claimed in claim 16, further comprising:
a detector capable of detecting the optical signal transmitted through the optical waveguide for every wavelength.

24. The optical transmission module as claimed in claim 23, wherein the detector includes
a first surface photo detector array for detecting at least two optical signals with the first wavelength; and
a second surface photo detector array for detecting at least two optical signals with the second wavelength different from the first wavelength.

25. The optical transmission module as claimed in claim 16, wherein the transmitter includes
a wavelength selecting portion for separating the exiting optical signal for every wavelength.
